(19) United States
(12) Patent Application Publication
(10) Pub. No.: US 2008/0166010 A1
(43) Pub. Date: Jul. 10, 2008

(54) Overlapping surround roll for loudspeaker

(76) Inventors: Enrique M. Stiles, Imperial Beach, CA (US); Richard C. Calderwood, Portland, OR (US)

Correspondence Address: RICHARD C. CALDERWOOD, 2775 NW 126TH AVE, PORTLAND, OR, 97229-8381, US

(21) Appl. No.: 11/649,653

(22) Filed: Jan. 4, 2007

(51) Int. Cl. H04R 19/02; H04R 1/00

(52) U.S. Cl. 381/423; 381/150

(57) ABSTRACT

A loudspeaker in which the voice coil diameter is so large that the voice coil is axially beneath the suspension roll of the surround. The surround has an overlapping suspension roll such that the inner portion of the surround is coupled to the diaphragm well inward of the bobbin. Such a transducer having greatly extended low frequency abilities by virtue of its wider, softer suspension roll enabling a much lower resonant frequency, and by virtue of its maximum sized magnet and voice coil yielding increased motor strength and power handling. Additionally, the dome diaphragm can now be vented through the portion of the dome that is beneath the surround roll, releasing the trapped back pressure below the diaphragm, thereby further lowering the resonant frequency.

### BACKGROUND OF THE INVENTION

1. Technical Field of the Invention

This invention relates generally to electromagnetic transducers, and more specifically to a loudspeaker whose surround suspension component extends radially inward and attaches to the diaphragm at a point significant inward of the diaphragm's outer perimeter.

2. Background Art

FIG. 1 illustrates a conventional loudspeaker 10, of the “microdriver” type typically used in applications such as laptop computers, desktop computer displays, and other applications in which space is at an absolute premium and very little can be spared for housing loudspeakers.

The loudspeaker includes an internal magnet geometry motor structure having a cup 12, an optional steel spacer plate 14, a permanent magnet 16, and a top plate 18 which defines a magnetic air gap with the cylindrical portion of the cup.

A frame 20 is coupled to the motor structure. A dome diaphragm 22 is coupled to the frame by a surround 24 having an outer portion 26 which is coupled to the frame, and an inner portion 28 which is coupled to the diaphragm at the outer perimeter 30 of the diaphragm. The middle roll portion of the surround provides the suspension characteristics of the surround, and partially contributes to the effective piston radiating area (Sd) of the loudspeaker. For a given material and thickness, a narrower, taller roll will generally be stiffer than a shorter, wider roll.

Suspension stiffness plays a significant part in determining the resonant frequency of the loudspeaker. The softer the suspension, the lower the resonant frequency, and the more efficiently the loudspeaker can reproduce low frequencies.

The loudspeaker has a predetermined maximum overall dimension. In the example shown, this dimension is determined by the outer diameter of the frame.

FIG. 2 illustrates a conventional loudspeaker 40 having the same predetermined maximum overall dimension, and specifically the same outer frame dimension. The loudspeaker includes an internal magnet geometry motor structure having a cup 42, a steel spacer 44, a magnet 46, and a top plate 48. A frame 50 is coupled to the motor structure. A dome diaphragm 52 is coupled to the frame by a surround 54 having an outer portion 56 coupled to the frame and an inner portion 58 coupled to the diaphragm at the outer perimeter 60 of the diaphragm. The middle roll portion of the surround is significantly wider and flatter, and thus softer, than that shown in FIG. 1. Thus, the loudspeaker of FIG. 2 will have a lower resonant frequency and more extended low frequency response than the loudspeaker of FIG. 1, assuming that the moving mass is nearly the same.

Unfortunately, this comes at a significant cost. In order to make room for the wider, flatter roll, while staying within the same predetermined maximum outer dimension (frame size), the loudspeaker of FIG. 2 has significantly reduced outer diaphragm dimension, bobbin diameter, voice coil 62 diameter, magnet diameter, top plate diameter, and magnetic air gap diameter. This reduces the strength and the power handling capabilities of the motor of FIG. 2, versus those of the motor of FIG. 1.

The strength of the motor is determined largely by its BL, which is the magnetic flux density (B) in the magnetic air gap times the total length (L) of the voice coil windings disposed in the magnetic air gap. The maximum sound pressure level (SPL) which the loudspeaker can generate is determined largely by the effective piston radiating area (Sd) of the diaphragm assembly and the maximum amount of axial excursion (Xcrash) through which the motor can move the diaphragm given the constraints of the motor geometry, the frame or basket clearances, and the suspension components. The greater the Xcrash and/or the greater the Sd, the greater the volume displacement and therefore the lower the useable frequency range of the loudspeaker.

But simply having adequate volume displacement capability to produce low frequencies is not enough. The speaker will also need to be efficient at producing those target low frequencies, if enclosure volume and/or amplifier power are limited.

The effective piston radiating area is limited of course by the dimensions of the frame within which the diaphragm must fit and have adequate clearance to move. And the effective piston radiating area is further limited by the size of the surround, because although the inner portion of the surround is moving equally with the diaphragm and contributing to sound output, the outer portion of the surround is fixed to the frame and is not contributing at all; in general, Sd may be approximated by measuring the effective diameter of the diaphragm assembly from the middle of the surround's roll.

In order to achieve high passband efficiency, the designer may wish to make the motor very strong. The designer may also wish to extend the bottom of the frequency range of the loudspeaker by increasing its excursion. But increasing the excursion requires a larger surround. Within the limitations of a fixed size frame (or cabinet), increasing the size of a conventional single roll surround has meant either (a) making the surround wider, which reduces the diameter of the inner portion of the surround which couples to the diaphragm, which in turn reduces the voice coil diameter and size of the magnet, resulting in a weaker motor, or (b) making the surround taller, which makes the surround stiffer, which raises the resonant frequency and reduces the low end response of the speaker.

What is needed is an improved loudspeaker configuration which allows both a large, flat surround roll for good, efficient low frequency response, and a large magnet and voice coil for good motor strength and power handling.

### BRIEF DESCRIPTION OF THE DRAWINGS

FIG. 1 shows a first loudspeaker according to the prior art, having a predetermined maximum overall outer dimension.

FIG. 2 shows a second loudspeaker according to the prior art, having the same predetermined maximum overall outer dimension and a softened suspension, with consequent reduction in diaphragm, voice coil, and magnet size.

FIG. 3 shows a cutaway view of a loudspeaker according to one embodiment of this invention.

FIG. 4 shows the loudspeaker of FIG. 3 in perspective view.

FIG. 5 shows the loudspeaker of FIG. 4 in exploded view.

FIG. 6 shows a loudspeaker according to another embodiment of this invention, using a bobbin which is not an integral part of the dome diaphragm.

FIG. 7 shows a loudspeaker according to another embodiment of this invention, using an inverted dome diaphragm.

FIG. 8 shows a loudspeaker according to yet another embodiment of this invention, using a different surround configuration.

FIG. 9 shows a loudspeaker having a surround which attaches to the diaphragm with a T-shaped inner portion to reduce peeling.

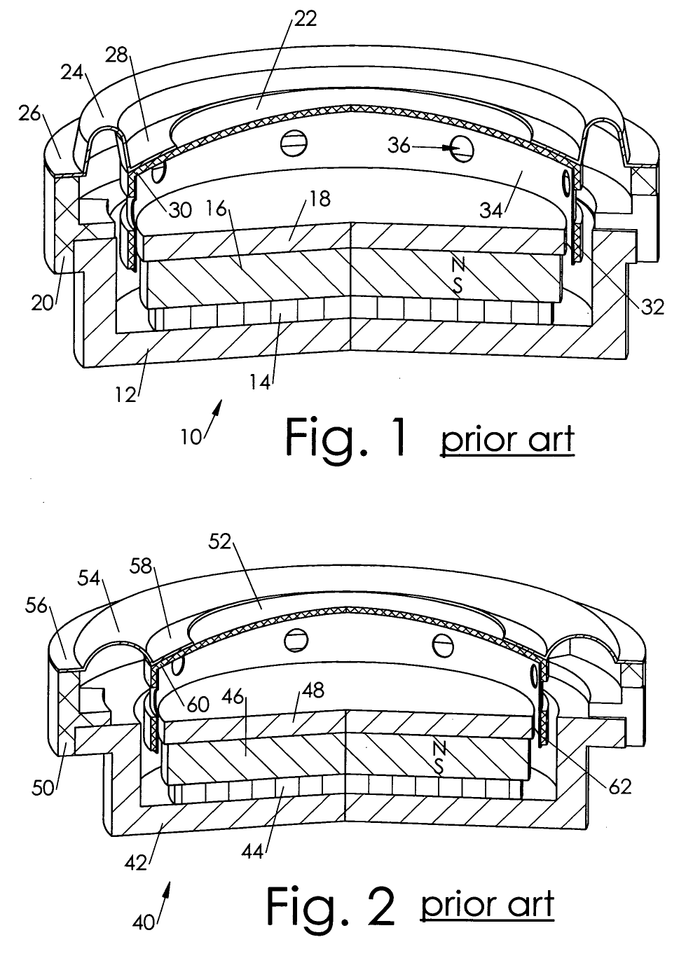

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

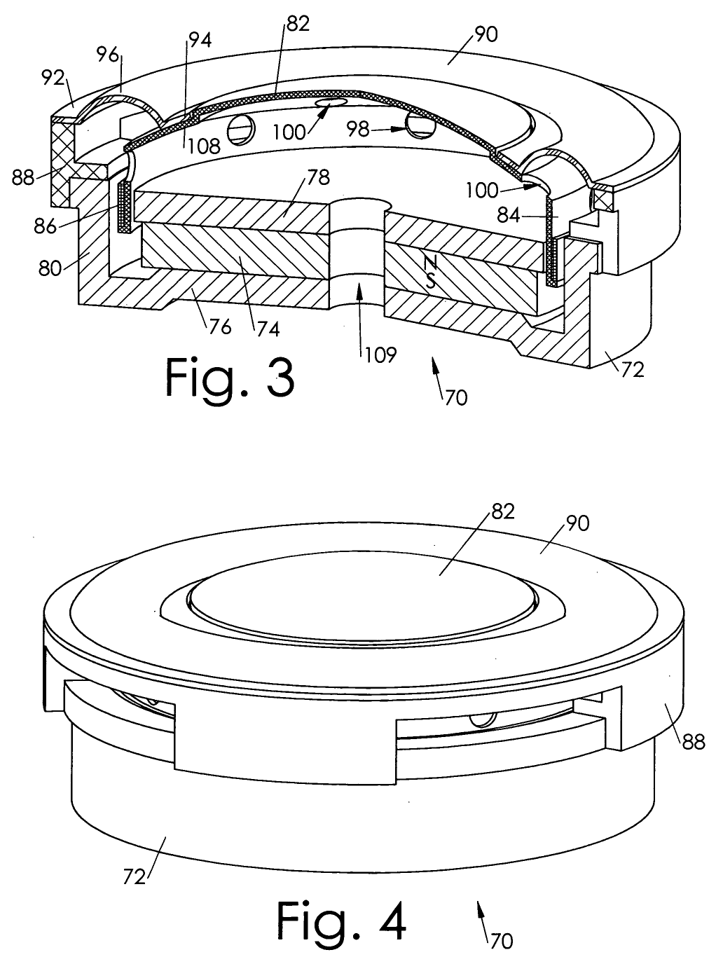

FIGS. 3-4 illustrate a loudspeaker 70 according to one embodiment of this invention. The loudspeaker includes an internal magnet geometry motor having a cup yoke 72, an internal magnet 74 magnetically coupled to the back plate portion 76 of the cup, and a top plate 78 magnetically coupled to the magnet and defining a magnetic air gap with a cylinder portion 80 of the cup. The outer perimeter of a diaphragm 82 is coupled to or integrally constructed with a bobbin 84, and a voice coil 86 is coupled to the bobbin and disposed in the magnetic air gap. A frame 88 is coupled to the cup, and a surround 90 has an outer portion 92 coupled to the frame and an inner portion 94 to a middle portion 108 of the diaphragm.

In the prior art, the voice coil (and thus the outer dimension of the internal magnet) were constrained to be inward of the position at which the surround was coupled to the diaphragm. However, in a loudspeaker utilizing this invention, the voice coil (and the outer dimension of the internal magnet) is not so constrained. Rather, the voice coil is so large as to be disposed axially below the surround's roll 96.

Having a large magnet and large voice coil significantly increases the strength and power handling of the motor. And having a surround which is significantly larger than would otherwise fit in the space between the frame's outer perimeter and the diaphragm's outer perimeter allows for a substantially softer suspension, which lowers the resonant frequency thereby allowing the speaker to more efficiently reproduce low frequencies and have an extended low end response.

Optionally, the diaphragm can be ventilated by holes 98 extending through the bobbin portion and/or by holes 100 extending through the portion of the dome beneath the surround. By coupling to the middle portion 96 of the diaphragm, the surround in effect seals the entire diaphragm and bobbin outward of where the surround attaches to the diaphragm, making that region, in effect, part of the back surface of the diaphragm. Optionally, the motor itself could also be ventilated such as by a conventional central bore 109.

In other embodiments, the frame may be omitted and the cup extended accordingly, such that the surround mounts directly to the cup.

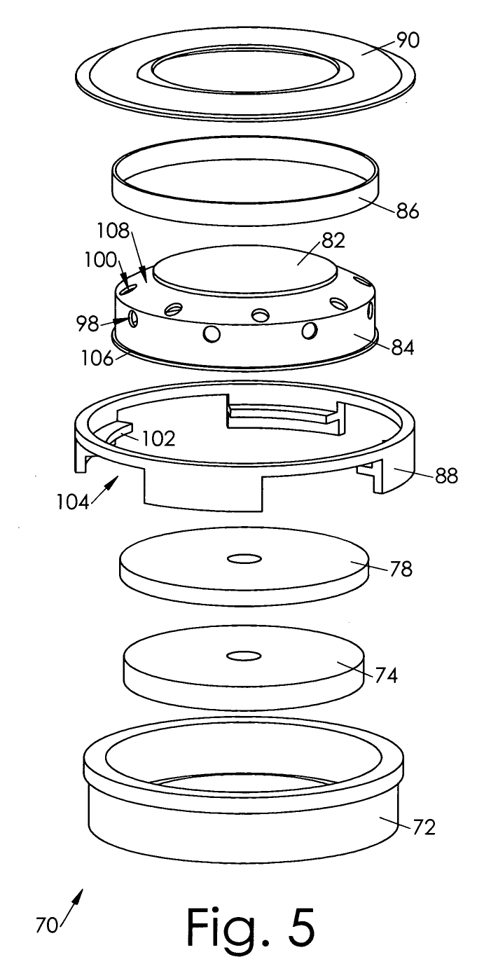

FIG. 5 illustrates the loudspeaker 70 in an exploded view. The loudspeaker includes a cup 72, magnet 74, top plate 78, frame 88, diaphragm 82, voice coil 86, and surround 90. The frame may optionally include flanges 102 for fixing the diaphragm assembly at a predetermined axial height with respect to the motor. The frame may also optionally include voids 104 which permit air flow to depressurize and cool the loudspeaker during operation. The diaphragm includes a cylindrical bobbin portion 84, which may optionally have a lip 106 for retaining the voice coil. The diaphragm may include holes 98 through its bobbin portion, and/or holes 100 through the outer portion of its dome portion, outward of a position 108 at which the surround will be coupled.

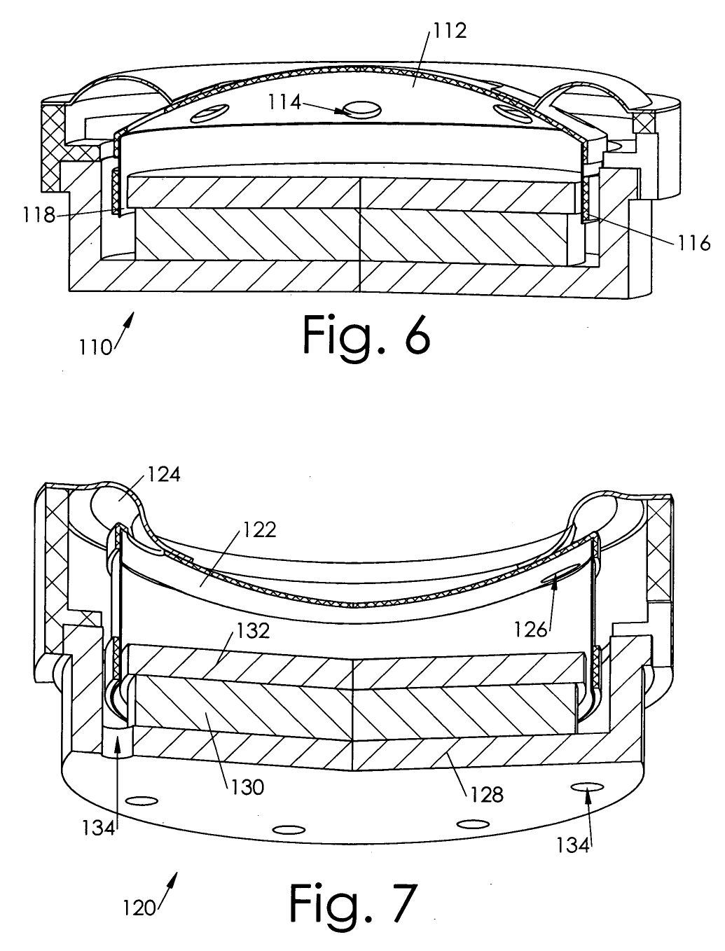

FIG. 6 illustrates a loudspeaker 110 according to another embodiment of this invention. The loudspeaker includes a diaphragm 112 which has ventilation holes 114 in its domed portion only. The voice coil 116 is wound on a separate bobbin 118 which, optionally, does not have a lip at its bottom margin.

In some loudspeakers which use a bobbin which is separate from the dome diaphragm, such as that shown, the bobbin is typically so short that there is no space in which to place ventilation holes through the bobbin. But using the overlapping surround roll of the present invention provides a space where ventilation holes may be placed through the dome diaphragm under the surround roll. Using such dome ventilation holes was not possible in the prior art, because it would have provided air flow between the front and back sides of the diaphragm resulting in acoustical cancellation (because the surround terminated at the edge of the diaphragm).

FIG. 7 illustrates a loudspeaker 120 according to yet another embodiment of this invention. The loudspeaker includes an inverted dome diaphragm 122 which is coupled to the frame by a surround 124 which attaches to the inverted dome at a position significantly inward from the inverted dome's outer perimeter. To provide clearance for the inverted dome, the frame and bobbin are taller than in previously described embodiments. The inverted dome is optionally ventilated with holes 126 which are radially outward of the position at which the surround attaches, such that they vent to the underside of the surround's roll. The motor is optionally also ventilated via a plurality of holes 134 formed through the cup 128. There may also, optionally, be an axial hole (not shown) through the center of the cup, magnet 130, and top plate 132.

In some configurations, depending on the shape of the surround roll and the placement of the holes through the diaphragm, the inner portion of the surround roll will act as a flapper valve, resulting in a partial DC air flow, which will cool the motor, further increasing the power handling of the speaker.

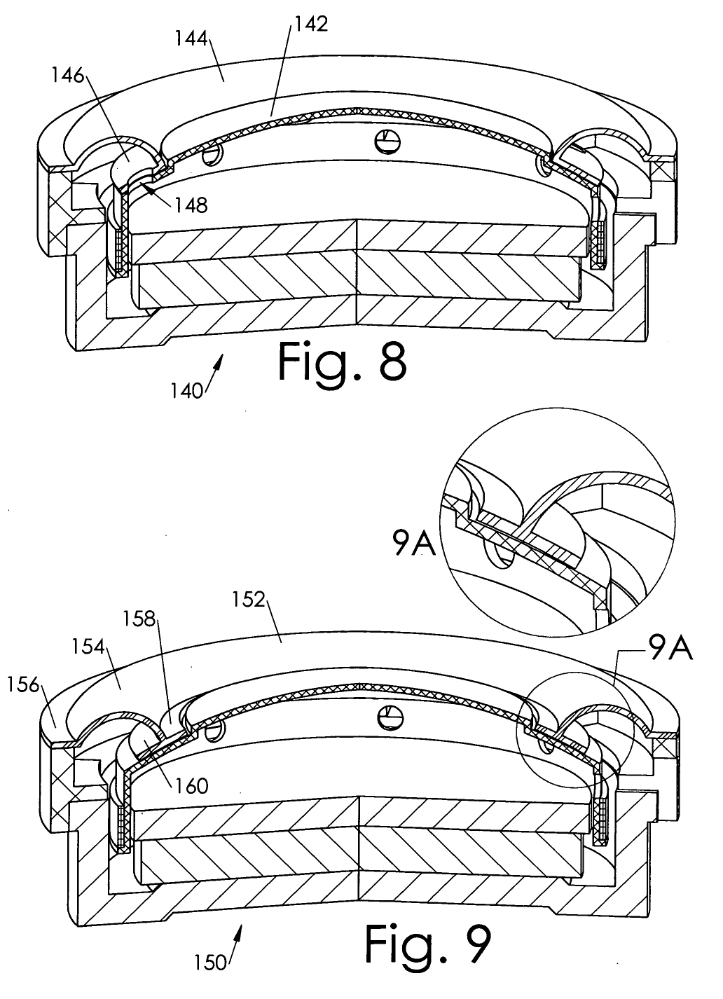

FIG. 8 illustrates a loudspeaker 140 according to yet another embodiment of this invention. The loudspeaker includes a dome diaphragm 142 which is supported by a surround 144 whose diaphragm attachment portion 146 extends radially outward, beneath the surround roll. That portion of the surround, and the underlying portion of the diaphragm, may be ventilated by holes 148.

FIG. 9 illustrates a loudspeaker 150 in which the surround 152 includes a roll portion 154, an outer portion 156 for attaching to the frame, and a T-shaped portion for attaching to the diaphragm. This T-shaped portion includes a portion 158 which extends generally radially inward, and a portion 160 which extends generally radially outward beneath the roll.

The advantage of this surround configuration is that it is less susceptible to peeling off of the diaphragm, which can happen to conventional surround attachment configurations after long periods of high power playing, especially in high temperature conditions. Because the roll does not terminate at an end of the attachment portion, it is far less able to cause peeling.

This T-shaped attachment configuration can be used in conjunction with the overlapping roll techniques taught elsewhere in this disclosure, but it can also be used in conjunction with conventional roll and conventional voice coil technologies.

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art, having the benefit of this disclosure, will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A loudspeaker comprising:
a motor structure having a magnetic air gap; and
a diaphragm assembly including,
a diaphragm having an outer perimeter and a middle portion,
a bobbin which is one of coupled to and integral with the outer perimeter of the diaphragm,
a voice coil coupled to the bobbin and disposed within the magnetic air gap, and
a surround having an outer portion coupled to the motor structure, an inner portion coupled to the middle portion of the diaphragm, and a suspension portion between the outer and inner portions;
wherein the voice coil is further disposed axially beneath the suspension portion of the surround.

2. The loudspeaker of claim 1 further comprising:
a frame coupled between the motor structure and the outer portion of the surround.

3. The loudspeaker of claim 1 wherein:
the bobbin is ventilated.

4. The loudspeaker of claim 1 wherein:
the diaphragm is ventilated beneath the suspension portion of the surround.

5. The loudspeaker of claim 1 further comprising:
a frame coupling the outer portion of the surround to the motor structure;
wherein the frame is ventilated to permit air flow from beneath the suspension portion of the surround.

6. The loudspeaker of claim 1 wherein:
the inner portion of the surround extends generally radially inward from the suspension portion of the surround.

7. The loudspeaker of claim 1 wherein:
the inner portion of the surround extends generally radially outward beneath the suspension portion of the surround.

8. The loudspeaker of claim 1 wherein:
the inner portion of the surround has a T-shaped configuration such that the suspension portion of the surround terminates at a location removed from ends of the inner portion of the surround.

9. A loudspeaker comprising:
an internal magnet geometry motor structure;
a diaphragm assembly including,
a diaphragm,
a bobbin coupled to the diaphragm
a voice coil coupled to the bobbin,
a surround having an outer portion coupled to the motor structure, an inner portion coupled to the diaphragm at a position generally radially inward from the voice coil, and a roll portion coupling the inner portion to the outer portion and providing suspension characteristics of the surround.

10. The loudspeaker of claim 9 wherein:
the roll portion of the surround comprises a single roll.

11. The loudspeaker of claim 9 further comprising:
a frame coupled to the outer portion of the surround and to the motor structure.

12. The loudspeaker of claim 9 wherein:
a diameter of the voice coil is at least 5% greater than an inner diameter of the roll portion of the surround.

13. The loudspeaker of claim 12 wherein:
a diameter of the voice coil is at least 10% greater than an inner diameter of the roll portion of the surround.

14. The loudspeaker of claim 13 wherein:
a diameter of the voice coil is at least 20% greater than an inner diameter of the roll portion of the surround.

15. The loudspeaker of claim 9 wherein:
a diameter of the voice coil is greater than 95% of a diameter of an effective piston radiating area of the diaphragm assembly.

16. The loudspeaker of claim 15 wherein:
a diameter of the voice coil is at least 100% of a diameter of an effective piston radiating area of the diaphragm assembly.
